(19) United States
(12) Patent Application Publication
(10) Pub. No.: US 2016/0276832 A1
(43) Pub. Date: Sep. 22, 2016

(54) ENERGY MANAGEMENT SYSTEM FOR ADJUSTING ENERGY SUPPLY AND DEMAND OF PLURALITY OF DISTRICTS, AND ENERGY MANAGEMENT METHOD

(71) Applicant: HITACHI, LTD., Tokyo (JP)

(72) Inventors: Junya KAWAI, Tokyo (JP); Kazunori SEKIYA, Tokyo (JP); Chiharu SAKAE, Tokyo (JP); Yutaka SANO, Tokyo (JP)

(73) Assignee: HITACHI, LTD., Tokyo (JP)

(21) Appl. No.: 15/028,183

(22) PCT Filed: Oct. 3, 2014
(86) PCT No.: PCT/JP2014/076578

§ 371 Date: Apr. 8, 2016

(30) Foreign Application Priority Data
Oct. 10, 2013 (JP) 2013-212410

(51) Int. Cl. H02J 3/14; G05B 19/042; H02J 13/00; H02J 3/32; H02J 7/00

(52) U.S. Cl. CPC H02J 3/14; H02J 3/32; H02J 7/0068; H02J 13/001; G05B 19/042; H02J 2003/003

(57) ABSTRACT

To integrally manage energy for a plurality of districts and optimize energy supply and demand of the plurality of districts. In order to manage energy for a plurality of districts including a plurality of facilities, an energy management system includes a management computer connected to the plurality of districts via a communication network. The management computer stores, for each district of the plurality of districts, an actual value of an amount of grid energy which is supplied from outside of the plurality of districts to facilities inside the district, an actual value of an amount of output energy which is output from the facilities in the district, and an actual value of an amount of consumed energy which is consumed by the facilities in the district, and calculates and outputs, for the district, predicted values in a specific time slot, based on the actual values.

### TECHNICAL FIELD

The present invention relates to energy management for a plurality of districts.

### BACKGROUND ART

A conventional microgrid is an independent grid cut off from a macrogrid or a grid with one coupling point to the macrogrid. Conventional microgrid control involves adjusting a supply-demand balance in a microgrid and adjusting an amount of received power at a macrogrid coupling point.

### SUMMARY OF INVENTION

### Technical Problem

The microgrid system described above includes problems such as the microgrid being required to own an amount of generated power satisfying demands in the microgrid, the microgrid being required to install all power distribution networks in the microgrid on its own, and all consumers in the microgrid being required to consent to being dependent on the microgrid for all power demands.

### Solution to Problem

In order to solve the problems described above, an energy management system that is an aspect of the present invention manages energy for a plurality of districts including a plurality of facilities. The energy management system includes a management computer connected to the plurality of districts via a communication network. The management computer includes: a data storage unit configured to store, for each district of the plurality of districts, an actual value of an amount of grid energy that indicates an amount of energy supplied from outside of the plurality of districts to facilities inside the district, an actual value of an amount of output energy that indicates an amount of energy output from the facilities in the district, and an actual value of an amount of consumed energy that indicates an amount of energy consumed by the facilities in the district; and a computing unit configured to calculate and output, for the district, a predicted value of the amount of grid energy, a predicted value of the amount of output energy, and a predicted value of the amount of consumed energy in a specific time slot, based on the actual value of the amount of grid energy, the actual value of the amount of output energy, and the actual value of the amount of consumed energy.

### Advantageous Effects of Invention

According to the aspect of the present invention, energy for a plurality of districts can be integrally managed and energy supply and demand of the plurality of districts can be optimized.

### BRIEF DESCRIPTION OF DRAWINGS

FIG. 1 illustrates a configuration of an area energy management system according to an embodiment of the present invention.

FIG. 2 is a diagram illustrating a configuration of a management server.

FIG. 3 illustrates information stored in a data storage unit.

FIG. 4 illustrates an initial setting table.

FIG. 5 illustrates an intra-district energy management list.

FIG. 6 illustrates a district unit energy management list.

FIG. 7 illustrates pattern information.

FIG. 8 illustrates a holding information table.

FIG. 9 is a flowchart illustrating an energy information management process.

FIG. 10 is a flow chart illustrating a plan determination process.

FIG. 11 illustrates a planning screen.

FIG. 12 is a flow chart illustrating an energy management process.

FIG. 13 illustrates a building management screen.

FIG. 14 illustrates a configuration of a power interchanging device.

FIG. 15 schematically illustrates a configuration of an area energy management system in a case where a district is added to a management area.

FIG. 16 illustrates a configuration of an area energy management system in a case where a power interchanging device is provided in another district.

FIG. 17 schematically illustrates a configuration of an area energy management system in a case where a power line in a district includes a plurality of sections.

### DESCRIPTION OF EMBODIMENTS

Hereinafter, an embodiment of the present invention will be described. It is to be understood that the present invention is not limited by the following description and other configurations that produce similar effects are also included in the present invention.

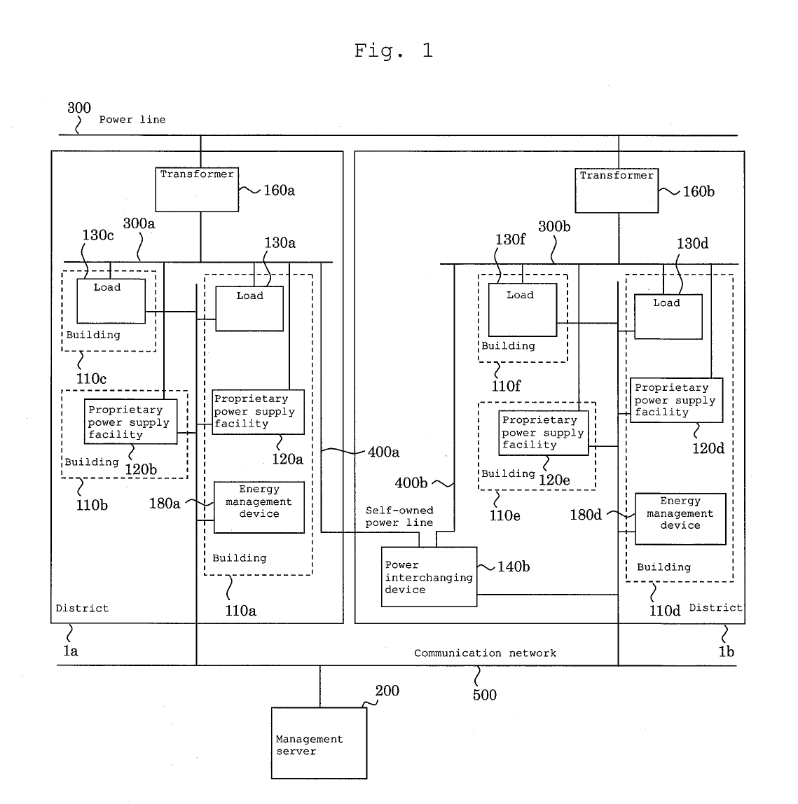

FIG. 1 illustrates a configuration of an area energy management system according to an embodiment of the present invention.

The area energy management system according to the present embodiment includes a plurality of districts 1a and 1b in a management area and a management server 200. In the present embodiment, supply and/or consumption of energy in each of the plurality of districts 1a and 1b is managed as energy information.

In this case, a “district” constitutes a part of a management area and refers to an arbitrary management unit with respect to energy. Specifically, a district may be a collection of buildings having similar or mutually different energy consumption attributes (a collection of general residences or a collection of commercial facilities), a collection of buildings existing in a specific positional range (for example, a collection of buildings existing within a 5 km radius from a station or a collection of buildings existing in a specific zone), or a collection of buildings whose construction dates are consistent (a tract-house development). The district is set by a developer who develops a group of districts including the district, a local municipality, a neighborhood association, or the like who manages the district, an entrusted company who is entrusted to manage energy for a management area by the local municipality, or the like. Moreover, energy management may be streamlined by including a collection of buildings with a same consumption attribute in one district. In addition, a district is premised on an independent grid.

Grid power is supplied to each of the districts 1a and 1b from a power supply company via a power line 300. In addition, a proprietary power supply facility may exist in a district. In this case, it is assumed that a proprietary power supply facility refers to a facility that generates renewable energy such as photovoltaic power generation, wind power generation, and biomass power generation or a cogeneration facility, a storage battery, or the like. A manager who manages a district performs intra-district or inter-district energy management by successively collecting information regarding grid power supplied to the district, statuses of power supply and consumption by buildings in the district, and the like from the management server 200. Hereinafter, proprietary power supply facility, a load, a power interchanging device, a power receiving facility that receives grid power such as a transformer, and the like may sometimes be collectively referred to as a “facility”. A part of or all of the buildings in a district owns a proprietary power supply facility which supplies power. A part of or all of the buildings in a district owns a load (a demand facility) which consumes power. In addition, a building may include a power interchanging device or a facility which receives grid power such as a transformer and a measurement device. Moreover, a district may not include a proprietary power supply facility, a load, or a power interchanging device.

In the present embodiment, the district 1a includes a transformer 160a, a power line 300a, buildings 110a and 110b, and a proprietary power supply facility 120c. The district 1b includes a transformer 160b, a power line 300b, buildings 110d and 110e, a proprietary power supply facility 120f, and a power interchanging device 140b. The building 110a includes a proprietary power supply facility 120a, a load 130a, and an energy management device 180a. The building 110b includes a load 130b. The building 110d includes a proprietary power supply facility 120d, a load 130d, and an energy management device 180b. The building 110e includes a load 130e. The proprietary power supply facilities 120a and 102c, the load 130a, and the load 130b in the district 1a are respectively connected to the power line 300 via the power line 300a and the transformer 160a. The proprietary power supply facilities 120d and 120f and the loads 130d and 130e in the district 1b are respectively connected to the power line 300 via the power line 300b and the transformer 160b.

The power interchanging device 140b in the district 1b is connected to the power line 300a in the other district 1a via a self-owned power line 400a and connected to the power line 300b in the district 1b to which the power interchanging device 140b belongs via a self-owned power line 400b. The power interchanging device 140b has a function of receiving power allocated from the other district 1a and supplying the received power to the district 1b to which the power interchanging device 140b belongs. Details of the configuration of the power interchanging device 140b will be described later.

The facilities and the energy management devices 180a and 180b in the buildings which exist in the districts 1a and 1b are connected to the management server 200 via a communication network 500. Each building may or may not have an energy management device. When a building has an energy management device, the facilities in the building may be connected to the energy management device instead of being directly connected to the communication network 500.

The management server 200 may exist in each district or one management server 200 may exist for a plurality of districts. The management server 200 according to the present embodiment integrally manages the districts 1a and 1b. A manager uses the management server 200 to collect energy information from the buildings in the districts 1a and 1b and manage supply and demand of energy for the districts while referring to predicted values which are predicted by a plan determination process to be described later. A detailed management method will be described later.

Each building in a district is connected to the power line 300 which supplies grid power and receives power from the power line 300.

In addition, respective buildings may be connected to each other via a self-owned power line or a power interchanging device. In this case, power can be mutually supplied among a plurality of buildings.

In the present embodiment, owners of buildings in a district, tenants in the buildings or owners of residences, occupants or managers of the buildings (hereinafter, “building managers”), and the like have consented to provide self-owned proprietary power supply facilities for the purpose of intra-district and inter-district energy management. However, consent need not necessarily be obtained for all buildings in a district and the manager may only manage buildings for which consent has been obtained.

In this case, “providing a proprietary power supply facility” specifically refers to utilizing energy (in the present embodiment, energy mainly refers to power) which is produced, accumulated, released, managed, and the like by a proprietary power supply facility for the purposes of peak cutting of received grid power in the district that includes the proprietary power supply facility and intra-district or inter-district leveling of received grid power.

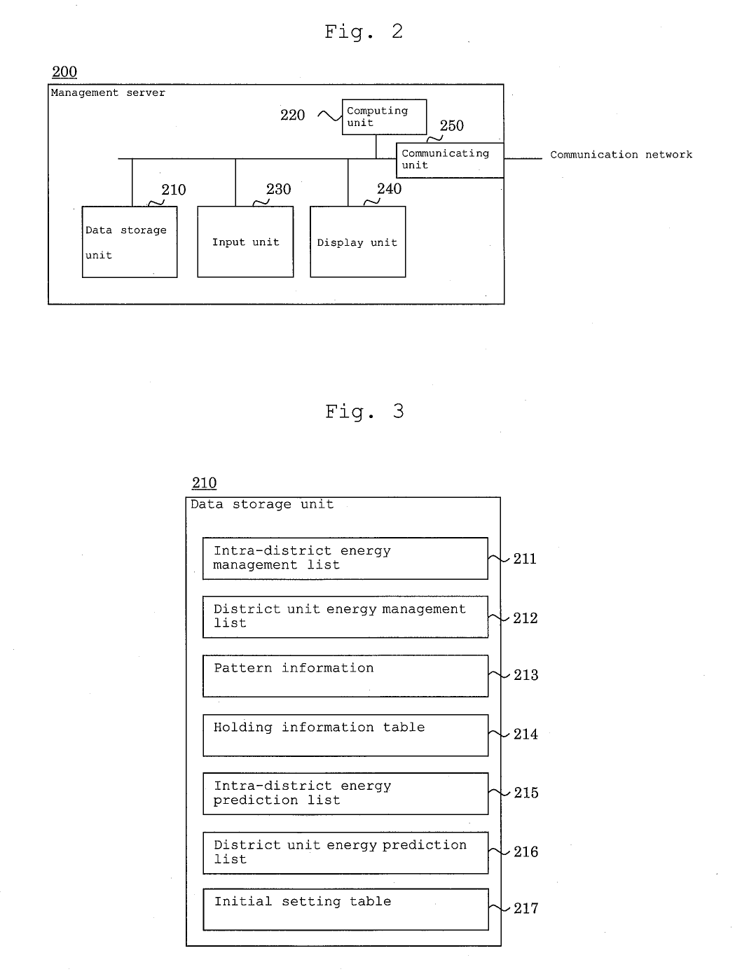

FIG. 2 is a diagram illustrating a configuration of the management server 200.

The management server 200 has a similar configuration to a general computer. Specifically, the management server 200 includes a data storage unit 210, a computing unit 220, an input unit 230, a display unit 240, and a communicating unit 250. The data storage unit 210 stores programs and data for processes to be performed by the management server 200. The computing unit 220 executes processes of the management server 200 in accordance with the programs and data. The programs may be stored in a computer-readable recording medium or may be read out from the recording medium into the data storage unit 210. The input unit 230 accepts an input from the manager. The display unit 240 displays information generated by the computing unit 220. The communicating unit 250 is connected to the communication network 500 and transmits and receives information to and from other devices. Moreover, a management terminal device that is operated by the manager may be connected to the management server 200 via the communication network 500. The management terminal device displays information received from the management server 200 in place of the display unit 240 and transmits input from the manager to the management server 200 in place of the input unit 230.

The management server 200 is connected via the communication network 500 to energy management devices and measurement devices such as sensors and meters inside buildings in a management area. In addition, the management server 200 collects actual measurement values as measured by the measurement devices provided on facilities in the buildings as energy information. Energy information may include setting values which are set with respect to electric facilities.

The management server 200 mainly performs an energy information management process, a plan determination process, and an energy management process described below.

### 1. Energy Information Management Process

The management server 200 manages energy information indicating energy information produced, accumulated, and consumed in the districts 1a and 1b. Specifically, the management server 200 displays energy information collected from the buildings in the districts in district units and detects and displays grid power failures.

### 2. Plan Determination Process

The management server 200 collects data such as previous energy consumption history, event schedules, and meteorological information with respect to the districts 1a and 1b managed by the management server 200, predicts energy supply and energy consumption in the districts 1a and 1b managed by the management server 200, and determines an energy management plan based on the predictions. Details of the plan determination process will be given later.

### 3. Energy Management Process

Based on the plan determination process, the management server 200 manages energy consumption and energy supply in the districts managed by the management server 200, and changes the energy management plan when a situation exceeding the predictions occurs. In addition, the energy management process also controls power interchange between the districts.

In the present embodiment, each district performs intra-district or inter-district power interchange through self-owned power lines laid between districts or self-owned power lines laid between buildings while receiving grid power from the power line 300. In other words, a given building may simultaneously receive grid power and power interchange. Hereinafter, such power reception will be referred to as “parallel power reception”.

In addition, in the present embodiment, it is assumed that a district performs parallel power reception when an amount of consumed energy of power in the district exceeds an estimated amount of supplied energy and, in a state where the consumption amount is below the estimated amount of supplied energy, the district basically procures power from grid power or from a proprietary power supply facility in the district. The amount of consumed energy for a district indicates an amount of energy that is consumed by loads in the district. The amount of supplied energy for a district is a sum of an amount of grid energy which is an amount of energy supplied to the district from a grid outside of the management area and an amount of output energy which is an amount of energy output from proprietary power supply facilities in the district. In the present embodiment, the amounts of energy are expressed by power. In other words, the amount of grid energy for a district is power which the district receives from the grid. Moreover, parallel power reception may possibly also be performed when an amount of generated power in a district exceeds an estimated amount.

In the present embodiment, the management server 200 separately manages the amount of energy supplied to a district from a grid outside of the management area and the amount of energy produced inside the district. Accordingly, the management server 200 perform energy interchange only on energy produced in the district to be allocated to other districts and does not perform energy interchange to allocate energy, which has been supplied to the district from the grid, to other districts. In the present embodiment, energy produced in the district includes power generated inside the district and power charged in a storage battery from power generated inside the district. In addition, in the present embodiment, energy supplied to the district from the grid includes power supplied to the district from the grid and power charged in a storage battery from power supplied to the district from the grid. The management server 200 manages a remaining charge of a storage battery by dividing the remaining charge into a power amount charged by grid power and a power amount from power generated inside the district, and manages the power amount from power generated inside the district as an interchangeable remaining charge. In other words, an amount of interchanged energy that is an amount of energy allocated from the district to another district is equal to or less than an amount of energy produced in the district and an amount of energy output from the interchangeable remaining charge of the district.

Furthermore, in the energy management process, the management server 200 aggregates information necessary for managing a building into one building management screen and causes the building management screen to be displayed on a display device of an energy management device or the like which is managed by a building manager. For example, information such as consumption amounts of respective forms of energy (such as water, power, gas, and heat), meteorological information, a reduction target and an attainment rate of energy and CO₂, notices regarding rolling blackouts or the like at the time of display is displayed to the building manager. Details of the energy management process will be provided later.

Hereinafter, information stored in the data storage unit 210 will be described.

FIG. 3 illustrates information stored in the data storage unit 210.

The data storage unit 210 stores, in the form of a database, data necessary for performing the energy information management process, the plan determination process, and the energy management process described above. The data storage unit 210 stores an intra-district energy management list 211, a district unit energy management list 212, pattern information 213, a holding information table 214, an intra-district energy prediction list 215, a district unit energy prediction list 216, and an initial setting table 217.

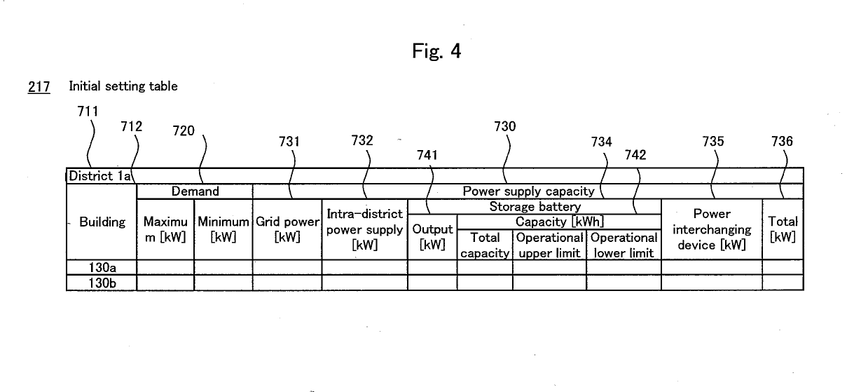

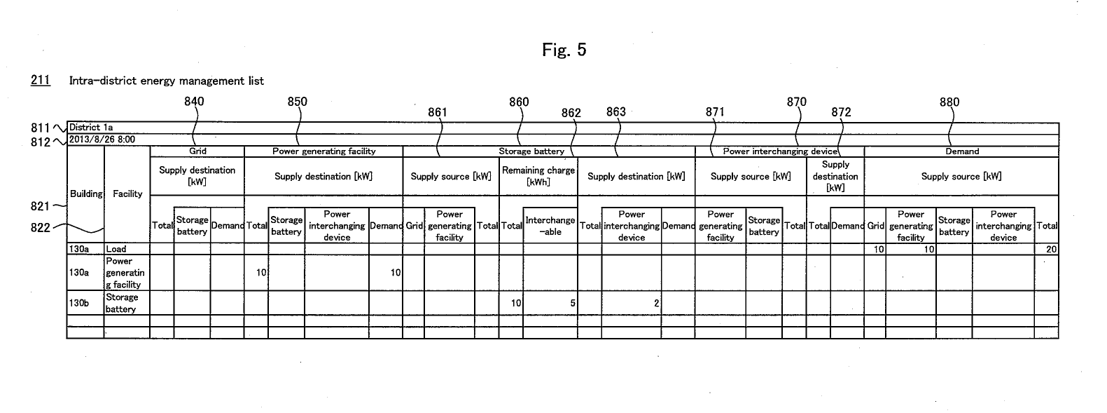

FIG. 4 illustrates the initial setting table 217.

The initial setting table 217 is a table stored for each district and indicates ranges of an amount of consumed energy, an amount of grid energy, an amount of output energy, and the like which are set for each district. The initial setting table 217 includes district information 711 which specifies the district and contains an entry for each building in the district. The entry for each building includes building information 712, demand information 720, and power supply capacity information 730. The building information 712 is information which specifies the building. The demand information 720 indicates a range of demand for power by the building. The power supply capacity information 730 indicates power that can be supplied to the building.

The demand information 720 includes a maximum demand value 721 and a minimum demand value 722. The power supply capacity information 730 includes grid power information 731, intra-district power supply information 732, storage battery information 734, power interchanging device information 735, and a total 736. The grid power information 731 indicates an upper limit of grid power that the building receives from the grid and is, for example, contracted power which is determined based on a contract with a power supply company. The intra-district power supply information 732 indicates an upper limit of power generated by power generating facilities in the building. The storage battery information 734 indicates an output and a capacity of storage batteries in the building. The power interchanging device information 735 indicates, when the building is a power interchanging device, an upper limit of power output by the power interchanging device. The total 736 indicates a sum of power indicated by the grid power information 731, the intra-district power supply information 732, the storage battery information 734, and the power interchanging device information 735. The storage battery information 734 includes an output 741 and capacity information 742. The output 741 indicates an upper limit of power discharged by the storage battery. The capacity information 742 indicates information related to a capacity of the storage battery. The capacity information 742 includes a total capacity, an operational upper limit, and an operational lower limit. In this case, a total capacity indicates a power amount that can be stored by the storage battery. An operational upper limit indicates an operational upper limit of power that is stored by the storage battery. An operational lower limit indicates an operational lower limit of power that is stored by the storage battery.

The management server 200 creates the initial setting table 217 based on input from the manager as preparation for energy management.

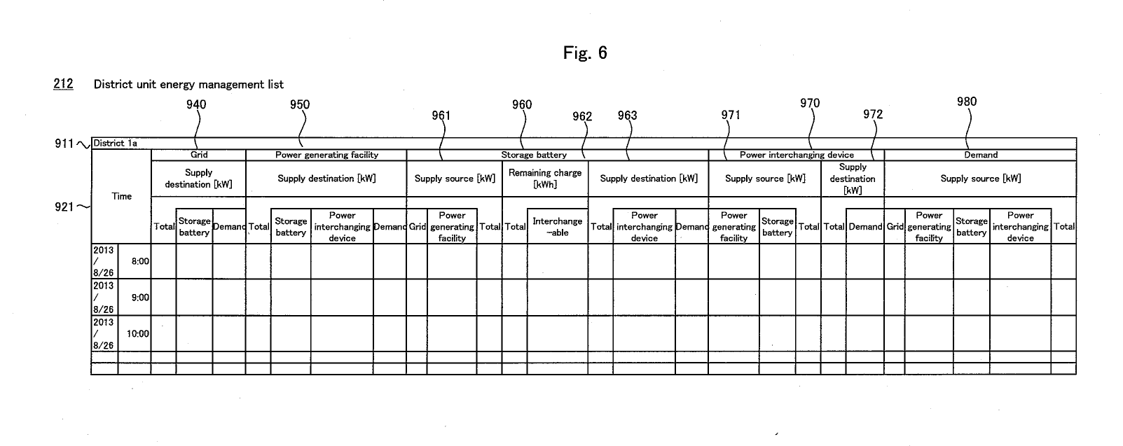

FIG. 5 illustrates the intra-district energy management list 211.

The intra-district energy management list 211 is a table stored for each district and for each time slot divided by a prescribed period of time and indicates energy information acquired from a building in each time slot in each district. The prescribed period of time is, for example, 1 hour. The intra-district energy management list 211 corresponding to a given time slot of a given district includes district information 811 indicating the district and time slot information 812 indicating a date and a start time of the time slot and contains an entry for each facility in the district. The entry for each facility includes building information 821, facility information 822, time slot information 823, grid information 840, power generating facility information 850, storage battery information 860, power interchanging device information 870, and demand information 880. The grid information 840 indicates, in a case where the facility is a power receiving facility, a state of the facility. The power generating facility information 850 indicates, in a case where the facility is a power generating facility, a state of the facility. The storage battery information 860 indicates, in a case where the facility is a storage battery, a state of the facility. The power interchanging device information 870 indicates, in a case where the facility is a power interchanging device, a state of the facility. The demand information 880 indicates, in a case where the facility is a load, a state of the facility.

The grid information 840 includes a total, a storage battery quota, and a demand quota. In this case, the total indicates a sum of power to a plurality of supply destinations in the district from grid power. The storage battery quota indicates power supplied to storage batteries in the district from grid power. The demand quota indicates power supplied to loads in the district from grid power. The grid information 840 may be determined from storage battery information 860 or demand information 880 which indicate power reception from grid power.

The power generating facility information 850 includes a total, a storage battery quota, a power interchanging device quota, and a demand quota. In this case, the total indicates a sum of power to a plurality of supply destinations in the district from the power generating facility. The storage battery quota indicates power supplied to storage batteries in the district from the power generating facility. The demand quota indicates power supplied to power interchanging devices in the district from the power generating facility. The demand quota indicates power supplied to loads in the district from the power generating facility.

The storage battery information 860 includes supply source information 861, remaining charge information 862, and supply destination information 863. In this case, supply source information 861 indicates power supplied to the storage battery. The remaining charge information 862 indicates a remaining charge of the storage battery. The supply destination information 863 indicates power supplied from the storage battery. The supply source information 861 includes a grid quota, a power generating facility quota, and a total. In this case, the grid quota indicates power supplied to the storage battery from grid power. The power generating facility quota indicates power supplied to the storage battery from the power generating facilities in the district. The total indicates a sum of power supplied to the storage battery. The remaining charge information 862 includes a total and an interchangeable remaining charge. In this case, the total indicates a power amount (a remaining charge) stored in the storage battery. The interchangeable remaining charge indicates a power amount that is interchangeable to other districts in the power amount. The supply destination information 863 includes a total, a power interchanging device quota, and a demand quota. In this case, the total indicates a sum of power supplied to the district from the storage battery. The power interchanging device quota indicates power supplied to other districts from the storage battery via a power interchanging device. The demand quota indicates power supplied to loads in the district from the storage battery.

The power interchanging device information 870 includes supply source information 871 and supply destination information 872. While a power interchanging device in a district may implement power interchange to allocate power to other districts and may receive power allocated from other districts, in the present example, the power interchanging device 140b in the district 1b receives power allocated from the other district 1a. The supply source information 851 is used when the power interchanging device implements power interchange to allocate power to other districts and indicates power supplied to the power interchanging device. The supply destination information 872 is used when the power interchanging device receives power allocated from other districts and indicates power supplied from the power interchanging device. The supply source information 871 includes a power generating facility quota, a storage battery quota, and a total. In this case, the power generating facility quota indicates power supplied to other districts from the power generating facilities in the district via the power interchanging device. The storage battery quota indicates power supplied to other districts from the storage batteries in the district via the power interchanging device. The total indicates a sum of power, supplied to other districts from the district via the power interchanging device. The supply destination information 872 includes a total and a demand quota. In this case, the total indicates a sum of power supplied to the district from other districts via the power interchanging device. The demand quota indicates power supplied to loads in the district from other districts via the power interchanging device.

The demand information 880 includes a grid quota, a power generating facility quota, a storage battery quota, a power interchanging device quota, and a total. In this case, the grid quota indicates power supplied to the load from grid power. The power generating facility quota indicates power supplied to the load from the power generating facilities in the district. The storage battery quota indicates power supplied to the load from the storage batteries in the district. The power interchanging device quota indicates power supplied to the load from other districts via a power interchanging device. The total indicates a sum of power supplied to the load.

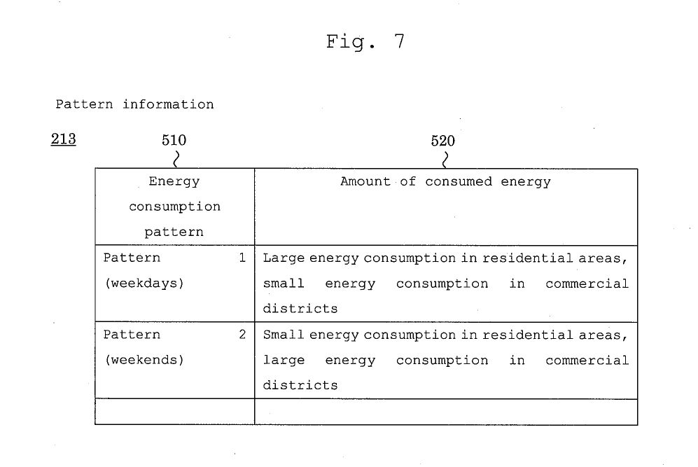

FIG. 6 illustrates the district unit energy management list 212.

The district unit energy management list 212 is a table stored for each district. The district unit energy management list 212 is obtained by aggregating values in the intra-district energy management list 211 for all buildings in a corresponding district. The district unit energy management list 212 corresponding to a given district includes district information 911 that specifies the district and contains an entry for each time slot. The entry for each time slot includes time slot information 921, grid information 940, power generating facility information 950, storage battery information 960, power interchanging device information 970, and demand information 980. The time slot information 930 indicates a date and a start time of the time slot. The grid information 940 indicates a state of power reception from grid power to the district. The power generating facility information 950 indicates a state of power generating facilities in the district. The storage battery information 960 indicates a state of storage batteries in the district. The power interchanging device information 970 indicates a state of power interchanging devices connected to power lines in the district. The power interchanging devices may be provided in the district or may be provided in other districts. The demand information 980 indicates a state of demand by loads in the district.

The grid information 940 includes a total, a storage battery quota, and a demand quota. In this case, the total indicates a sum of power to a plurality of supply destinations in the district from grid power. The storage battery quota indicates power supplied to storage batteries in the district from grid power. The demand quota indicates power supplied to loads in the district from grid power.

The power generating facility information 950 includes a total, a storage battery quota, a power interchanging device quota, and a demand quota. In this case, the total indicates a sum of power to a plurality of supply destinations in the district from the power generating facilities in the district. The storage battery quota indicates power supplied to storage batteries in the district from the power generating facilities in the district. The demand quota indicates power supplied to power interchanging devices in the district from the power generating facilities in the district. The demand quota indicates power supplied to loads in the district from the power generating facilities in the district.

The storage battery information 960 includes supply source information 961, remaining charge information 962, and supply destination information 963. In this case, supply source information 961 indicates power supplied to the storage batteries in the district. The remaining charge information 962 indicates a remaining charge of the storage batteries in the district. The supply destination information 963 indicates power supplied from the storage batteries in the district. The supply source information 961 includes a grid quota, a power generating facility quota, and a total. In this case, the grid quota indicates power supplied to the storage batteries in the district from grid power. The power generating facility quota indicates power supplied to the storage batteries in the district from the power generating facilities in the district. The total indicates a sum of power supplied to the storage batteries in the district. The remaining charge information 962 includes a total and an interchangeable remaining charge. In this case, the total indicates a power amount (a remaining charge) stored in the storage batteries in the district. The interchangeable remaining charge indicates a power amount that is interchangeable to other districts in the power amount. The supply destination information 963 includes a total, a power interchanging device quota, and a demand quota. In this case, the total indicates a sum of power supplied to the district from the storage batteries in the district. The power interchanging device quota indicates power supplied to other districts from the storage batteries in the district via a power interchanging device. The demand quota indicates power supplied to loads in the district from the storage batteries in the district.

The power interchanging device information 970 includes supply source information 971 and supply destination information 972. The supply source information 971 indicates, when a power interchanging device connected to a power line in the district implements power interchange to allocate power to other districts, power supplied to the power interchanging device. The supply destination information 972 indicates, when a power interchanging device connected to a power line in the district receives power allocated from other districts, power supplied from the power interchanging device. The supply source information 971 includes a power generating facility quota, a storage battery quota, and a total. In this case, the power generating facility quota indicates power supplied to other districts from the power generating facilities in the district via a power interchanging device. The storage battery quota indicates power supplied to other districts from the storage batteries in the district via a power interchanging device. The total indicates a sum of power supplied to other districts from the district via a power interchanging device. The supply destination information 972 includes a total and a demand quota. In this case, the total indicates a sum of power supplied to the district from other districts via a power interchanging device. The demand quota indicates power supplied to loads in the district from other districts via a power interchanging device.

The demand information 980 includes a grid quota, a power generating facility quota, a storage battery quota, a power interchanging device quota, and a total. In this case, the grid quota indicates power supplied to loads in the district from grid power. The power generating facility quota indicates power supplied to the loads in the district from the power generating facilities in the district. The storage battery quota indicates power supplied to the loads in the district from the storage batteries in the district. The power interchanging device quota indicates power supplied to the loads in the district from the power interchanging devices in the district. The total indicates a sum of power supplied to the loads in the district.

Moreover, the intra-district energy management list 211 and the district unit energy management list 212 include a history of previous actual values in addition to a current state and are maintained in the data storage unit 210 throughout a prescribed history period. Due to the intra-district energy management list 211 and the district unit energy management list 212 including a history of previous actual values, a predicted value of a time slot having a same trend as a time slot contained in the history can be calculated.

FIG. 7 illustrates the pattern information 213.

The pattern information 213 stores a plurality of energy consumption patterns which indicate a pattern of an amount of consumed energy in a management area. The pattern information 213 includes an entry for each energy consumption pattern. Each entry includes energy consumption pattern information 510 and an amount of consumed energy 520. The energy consumption pattern information 510 is information that specifies an energy consumption pattern and indicates a time slot type or an event type. The amount of consumed energy 520 indicates an amount of consumed energy set in advance. For example, an amount of consumed energy that is defined as a weekday energy consumption pattern represents a relatively large amount of consumed energy at residences and a relatively small amount of consumed energy at commercial facilities. In addition, for example, an amount of consumed energy that is defined as a weekend energy consumption pattern represents a small amount of consumed energy at residences and a large amount of consumed energy at commercial facilities. In a case where respective districts are constituted by buildings with similar energy consumption attributes, the districts can be assigned with energy consumption patterns individually. The use of the pattern information 213 enables a predicted value of an amount of consumed energy to be calculated in accordance with characteristics of a district or a time slot.

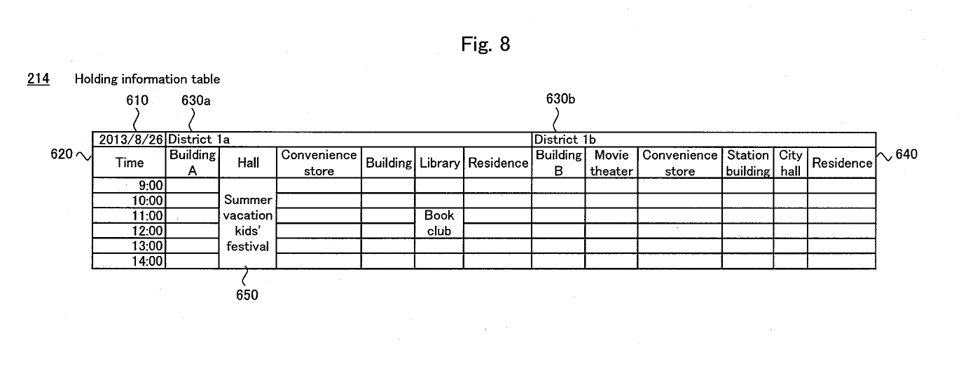

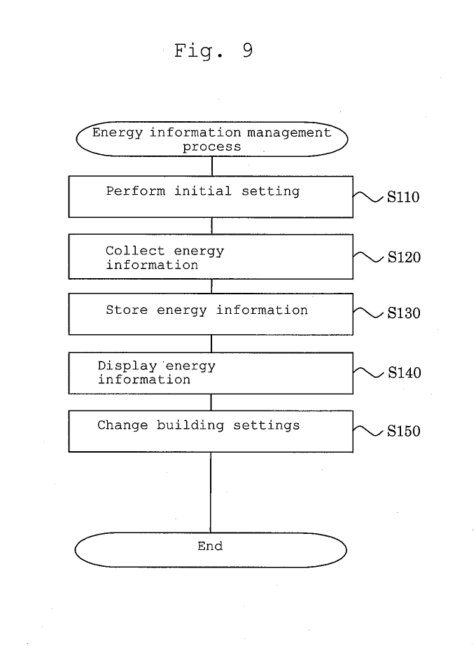

FIG. 8 illustrates the holding information table 214.

The holding information table 214 indicates events (functions) or the like in each district. The holding information table 214 is stored for each date. The holding information table 214 includes a date 610, a time 620 indicating a start time of a time slot, and district information 630a and 630b of each district. In this case, the district information 630a includes information specifying the district 1a and the district information 630b includes information specifying the district 1b. The district information 630a further includes building information 640 which specifies each building in the district. Event information 650 on an event to be held is set for each piece of building information 640 and for each time slot. The event information 650 indicates information that specifies an event, a period during which the event is to be held, and an energy consumption pattern type. The district information 630b is configured in a similar manner to the district information 630a.

Next, the intra-district energy prediction list 215 and the district unit energy prediction list 216 will be described.

The intra-district energy prediction list 215 has the same items as the actual values of the intra-district energy management list 211 described earlier and stores predicted values of the items. In contrast to the intra-district energy management list 211 indicating actual values of energy information from a time slot preceding a current time slot by a prescribed history period to the current time slot, the intra-district energy prediction list 215 indicates predicted values of energy information from the current time slot to a time slot following a prescribed prediction period after the current time slot.

The district unit energy prediction list 216 has the same items as the actual values of the district unit energy management list 212 described earlier and stores predicted values of the items. In contrast to the district unit energy management list 212 indicating actual values of energy information from a time slot preceding a current time slot by a prescribed history period to the current time slot, the district unit energy prediction list 216 indicates predicted values of energy information from the current time slot to a time slot following a prescribed prediction period after the current time slot.

In addition, although not illustrated, the data storage unit 210 may store previous meteorological information and weather forecast information. Moreover, the management server 200 may obtain such information at anytime from an outside server via the communication network 500.

Hereinafter, procedures of the respective processes performed by, the management server 200 will be described.

The energy information management process will now be described.

FIG. 9 is a flow chart illustrating the energy information management process.

First, as initial setting, the management server 200 registers district information in the data storage unit 210 in accordance with an instruction from the manager (S110). Specifically, the manager inputs an instruction to the management server 200 using the input unit 230 so as to create the initial setting table 217 and the district unit energy management list 212 of a specific district. After the instruction is input, when the district is absent from the initial setting table 217 and the district unit energy management list 212 in the data storage unit 210, the management server 200 newly creates tables and subsequently registers information on the new district in the initial setting table 217 and the district unit energy management list 212. Specifically, district information specifying the district is registered in the initial setting table 217 and the district unit energy management list 212. When the initial setting table 217 and the district unit energy management list already exist, the management server 200 registers new setting information in the setting information of the district which already exists in the district unit energy management list 212.

Next, the manager inputs an instruction to create the initial setting table 217 and the intra-district energy management list 211 with respect to the district to the input unit 230. Specifically, the management server 200 causes the display unit 240 to display guidance for creating the initial setting table 217 and the intra-district energy management list 211. The manager inputs building information specifying buildings in the district and setting information of facilities included in the buildings according to the guidance. Based on the input setting information, the management server 200 stores the setting information in the data storage unit 210. Moreover, instead of having the manager input information on buildings, the management server 200 may automatically collect information on buildings via the communication network from energy management devices of the buildings existing in the district to create the list. When there are a plurality of districts to be set, the creation of the list is repetitively performed for each district.

After the initial setting is completed, the management server 200 regularly collects energy information from the buildings in each district via the communication network 500 (S120). The management server 200 may regularly collect energy information or energy information may be manually collected by the manager by inputting instructions to the management server 200. The management server 200 registers input energy information in the intra-district energy management list 211 (S130). In addition, the management server 200 also updates the district unit energy management list by aggregating actual values in the intra-district energy management list 211 for all buildings in a district.

Moreover, the intra-district energy management list 211 may not include information indicating supply destination facilities or information indicating supply source facilities and may only include a total of such facilities. In this case, after aggregating the intra-district energy management list 211, the management server 200 may distribute the total in the district unit energy management list 212 to the respective facilities according to an instruction from the manager.

The management server 200 aggregates the energy information collected in this manner and causes the display unit 240 of the management server 200 to display the aggregated information (S140). Examples of display contents include an amount of consumed energy at the time of display in district units, a history of the amount of consumed energy per hour, and a reduction target and an attainment rate of energy. Moreover, the management server 200 may cause another display device such as a management terminal device to display the display contents by transmitting the display contents via the communication network 500.

The manager can check the display contents and change an amount of consumed energy and an amount of output energy which are set in the initial setting table 217 in district units or building units. Specifically, the manager specifies a district or a building which is an object of setting change via the input unit 230 of the management server 200. In addition, the manager inputs an instruction to the input unit 230 so as to change an amount of consumed energy or an amount of output energy for the specified building. The management server 200 having accepted the input transmits the instruction to the building via the communication network 500 (S150). A facility or an energy management device of the building having received the instruction changes the amount of consumed energy or the amount of output energy in accordance with the instruction.

Moreover, when changing the amount of consumed energy or the like of a building, the manager must obtain consent from a building manager who manages the building. To this end, prior to the change, the manager transmits a change approval request to the energy management device of the building manager using the manager's own management server 200. The building manager having received the approval request via the energy management device determines whether or not to approve the change in energy control and sends back the determination result. When the manager receives a reply indicating an approval of the change, the manager transmits contents of the change to the facility that is an object of the setting change or to an energy management device.

According to the energy information management process described above, information to be used for energy management of each district can be set and energy information in district units can be created and displayed based on energy information from each building.

Next, the plan determination process will be described.

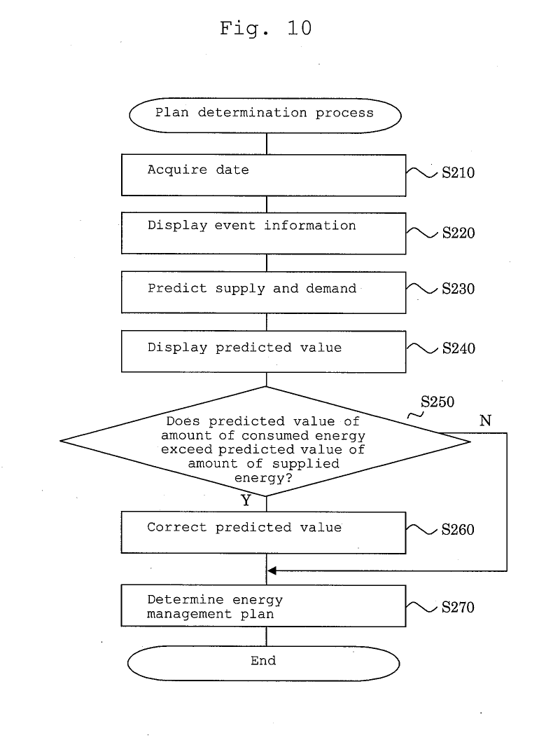

FIG. 10 is a flowchart illustrating a plan determination process.

First, the manager inputs a date for which the manager desires to predict production/demand and determine an energy management plan via the input unit of the management server 200 (S210). The management server 200 having accepted input of a date acquires event information for the date from the holding information table 214 and causes the event information to be displayed on the display unit 240 of the management server 200 (S220). The manager checks the displayed event information, corrects the event information on events planned in each district as appropriate, and inputs the corrected event information in the input unit 230. When registering an event as event information in the management server 200, the manager also inputs information that specifies an energy consumption pattern of the event. The management server 200 updates the holding information table 214 in accordance with the input.

Subsequently, the manager instructs the management server 200 to predict supply and demand of energy on the date. The management server 200 having received the instruction calculates an amount of consumed energy and an amount of supplied energy for each district as predicted values based on the initial setting table 217, previous intra-district energy management lists 211 and district unit energy management lists 212, the presence or absence of events on the date and energy consumption patterns corresponding to the events, and weather forecast information for the date which are stored in the data storage unit 210 (S230). As described earlier, the amount of supplied energy is a sum of the amount of grid energy and the amount of output energy. At this point, the management server 200 may use previous meteorological data corresponding to the date in place of weather forecast information.

Furthermore, the management server 200 causes a planning screen indicating the predicted values to be displayed on the display unit 240 (S240). The planning screen will be described later.

The manager determines an energy management plan based on the predicted values. Specifically, for each district in each time slot on the date, the management server 200 determines whether or not the predicted value of the amount of consumed energy exceeds the predicted value of the amount of supplied energy which is an amount of energy scheduled to be supplied (S250). At this point, the manager may check whether or not the displayed predicted value of the amount of consumed energy exceeds the displayed predicted value of the amount of supplied energy and make an input to the management server 200.

When the predicted value of the amount of consumed energy does not exceed the predicted value of the amount of supplied energy in all districts (S250: N), the management server 200 determines the predicted value as an energy management plan (S270). The energy management plan is to be used for an energy management process for the date.

When it is determined that the predicted value of the amount of consumed energy exceeds the predicted value of the amount of supplied energy in a given district (S250: Y), the manager performs the following assessment. For example, when it is determined that the predicted value of the amount of consumed energy exceeds the predicted value of the amount of supplied energy in the district 1b, the manager formulates a plan for implementing energy interchange to allocate energy from the district 1a to the district 1b and corrects the predicted value via the input unit 230 (S260). The management server 200 determines the corrected predicted value as an energy management plan (S270). In the present embodiment, energy to be interchanged is power. In this case, the manager corrects the predicted value so that, to the greatest extent feasible, the amount of interchanged energy is covered by output from power generating facilities including renewable energy and cogeneration or storage batteries located within the district 1a that is an interchange source. At this point, the manager corrects power output from storage batteries and power to be interchanged in the intra-district energy prediction list 215 and the district unit energy prediction list 216 so that interchange is performed by increasing output from the storage batteries located in the district 1a that is the interchange source and adopts the corrected power as an energy management plan, and uses the energy management plan in the energy management process for the date.

In addition, when it is predicted that the amount of consumed energy exceeds the amount of supplied energy in the district 1b and the deficit cannot be covered by interchange from other districts, the manager corrects numerical values in the intra-district energy prediction list 215 and the district unit energy prediction list 216 so that energy consumption in the district 1b is suppressed and adopts the corrected numerical values as an energy management plan, and uses the energy management plan in the energy management process for the date.

Moreover, even when it is predicted that the amount of consumed energy exceeds the amount of supplied energy in the district 1b and it is determined that the deficit can be covered by interchange from other districts, the manager can correct the predicted values so as to suppress energy consumption in the district 1b.

According to the plan determination process described above, the management server 200 can predict an amount of consumed energy and an amount of supplied energy for each district based on previous energy information, energy consumption patterns, information related to weather, and the like. Accordingly, the manager can determine an energy management plan based on the predictions. In addition, by interchanging power based on power generated by proprietary power supply facilities between districts using a power interchanging device, proprietary power supply facilities provided in any of a plurality of districts can be effectively utilized across districts. Accordingly, power reception of grid power in the plurality of districts can be suppressed and power reception can be prevented from exceeding contracted power. The plan determination process may be executed for each date or may be executed every prescribed period.

As described earlier, in the plan determination process, the management server 200 displays a planning screen integrating various types of information on the display unit 240.

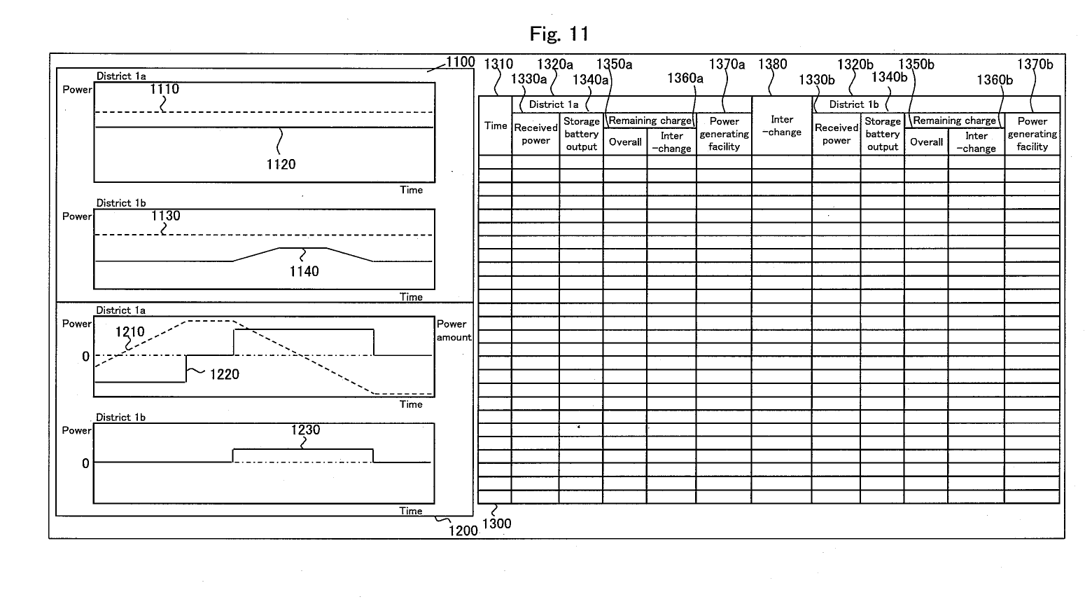

FIG. 11 illustrates a planning screen.

The planning screen includes, for example, a grid power reception state graph 1100, a power interchange state graph 1200, and management information 1300. The grid power reception state graph 1100 indicates a time variation in a power reception state from the grid for each district. The power interchange state graph 1200 indicates a time variation in a power interchange state between districts.

The grid power reception state graph 1100 is drawn for each district. In the grid power reception state graph 1100, a horizontal axis represents time and a vertical axis represents power. The grid power reception state graph 1100 according to the present embodiment includes contracted power 1110 of the district 1a, an amount of received power 1120 of the district 1a, contracted power 1130 of the district 1b, and an amount of received power 1140 of the district 1b. The contracted power 1110 and 1130 are set values indicated in the grid power information 731 in the initial setting table 217. The amounts of received power 1120 and 1140 are measurement results of power received from grid power and are actual values indicated in the grid information 940 in the district unit energy prediction list 116.

The power interchange state graph 1200 is drawn for each district. In the power interchange state graph 1200, a horizontal axis represents time and a vertical axis represents power or a power amount. The power interchange state graph 1200 according to the present embodiment includes a storage battery remaining charge 1210 of the district 1a, a storage battery output 1220 of the district 1a, and interchanged power 1230 of the district 1b. The storage battery remaining charge 1210 is the predicted value indicated in the remaining charge information 962 in the district unit energy prediction list 116 and indicates a power amount stored in the storage batteries of the district 1a. The storage battery output 1220 is the predicted values indicated in the supply source information 961 and the supply destination information 962 in the district unit energy prediction list 116 and indicates power input to and output from the storage batteries of the district 1a. The storage battery output 1220 expresses discharged power when storage batteries in the district 1a discharge by a positive sign and expresses charged power when storage batteries in the district 1a are charged by a negative sign. The interchanged power 1230 is the predicted value indicated in the power interchanging device information 970 in the district unit energy prediction list 116 and indicates a state of power interchange of the power interchanging device 140b. The interchanged power 1230 expresses received power when the district 1b that includes the power interchanging device 140b receives power from the district 1a through power interchange by a positive sign and expresses transmitted power when the district 1b transmits power to the district 1a through power interchange by a negative sign.

The plan represented by this example prevents the contracted power of the district 1b from being exceeded by charging the storage batteries in the district 1a and subsequently performing power interchange to allocate power from the storage batteries to the district 1b in a time slot in which the demand of the district 1b increases.

The management information 1300 is a table containing an entry for each time slot. Values in the management information 1300 are the predicted values in the district unit energy prediction list 116. The entry of each time slot includes time information 1310, district information for each district, and interchange information 1380. The time information indicates a start time of the time slot. The interchange information 1380 indicates power that is interchanged between the districts 1a and 1b. In a similar manner to the interchanged power 1230, power received by the district 1b which includes the power interchanging device 140b is expressed by a positive sign.

District information 1320a of the district 1a includes received power information 1330a, a storage battery output 1340a, an overall remaining charge 1350a, a remaining interchange charge 1360a, and a power generating facility output 1370a. The received power information 1330a indicates a predicted value of power which the district 1a receives from the grid during the time slot. The storage battery output 1340a indicates power input to and output from the storage batteries of the district 1a during the time slot and expresses discharged power by a positive sign in a similar manner to the storage battery output 1220 described earlier. The overall remaining charge 1350a indicates a power amount stored in the storage batteries in the district 1a during the time slot. The remaining interchange charge 1360a indicates a power amount that is interchangeable to other districts in the overall remaining charge 1350a. The power generating facility output 1370a indicates power generated by power generating facilities in the district 1a during the time slot. In a similar manner to the district information 1320a of the district 1a, district information 1320b of the district 1b includes received power information 1330b, a storage battery output 1340b, an overall remaining charge 1350b, a remaining interchange charge 1360b, and a power generating facility output 1370b.

According to the planning screen, the manager can view the planning screen to check predicted values and determine measures such as power interchange and suppression of an amount of consumed energy.

Next, the energy management process will be described.

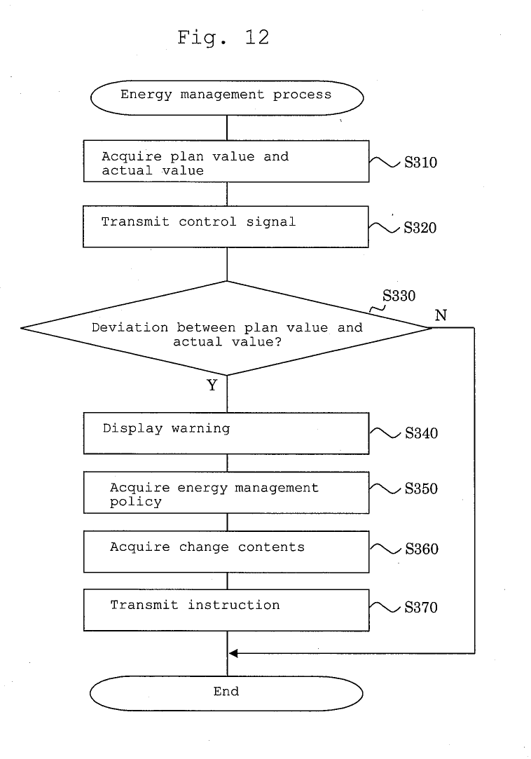

FIG. 12 is a flowchart illustrating the energy management process.

First, the manager inputs an instruction to the management server 200 using the input unit 230 to perform energy management using the energy management plan indicated in the intra-district energy prediction list 215 and the district unit energy prediction list 216 created in the plan determination process described above. The management server 200 having received the input searches in the data storage unit 210 for and acquires an energy management plan of a current time slot in the intra-district energy prediction list 215 and the district unit energy prediction list 216, acquires current energy information as an actual value (S310), and starts management.

Specifically, the management server 200 collects energy information in a similar manner to the energy information management process described above, stores the collected energy information as an actual value in the intra-district energy management list 211 and the district unit energy management list 212, and compares the actual value with a predicted value for the current time slot. In addition, the management server 200 determines whether or not the current actual value is consistent with the current predicted value. At this point, the manager may check whether or not the current actual value is consistent with the current predicted value. In accordance with the determination result, the management server 200 controls an object facility by transmitting an instruction to the facility via the communication network 500 so that a remaining charge of the storage batteries, discharged power of the storage batteries, and interchanged power indicated in the intra-district energy prediction list 215 and the district unit energy prediction list 216 assume the predicted value (S320). At this point, the management server 200 may control a facility by transmitting a control instruction to an energy management device of an object building and have the energy management device transmit an instruction to the facility.

For example, when a remaining charge of a storage battery of a convenience store in the district 1a is specified as 10 KW as of 10:00 in the intra-district energy prediction list 215, the management server 200 checks the remaining charge of the storage battery and controls the storage battery so that the remaining charge of the storage battery becomes 10 KW at 10:00.

In addition, for example, when power of 100 KW is set for power interchange to allocate power from the district 1a to the district 1b at 11:00 in the district unit energy prediction list 216, the management server 200 transmits an instruction via the communication network 500 to the power interchanging device 140b installed in the district 1b so as to receive power set as an amount of interchanged energy allocated from the district 1a.

A determination is made on whether or not a deviation has started between the predicted values set in the intra-district energy prediction list 215 and the district unit energy prediction list 216 and the actually collected current actual values indicated in the intra-district energy management list 211 and the district unit energy management list 212 (S330).

When it is determined that the predicted values and the current actual values have not deviated from each other (S330: N), the management server 200 ends this flow. When it is determined that the predicted values and the current actual values have deviated from each other (S330: Y), the management server 200 displays a warning on the display unit 240 (S340). A timing of outputting a warning can be set in the management server 200 by the manager in advance. For example, conceivable timings include a case where the deviation of an actual value from a predicted value in a given district reaches a threshold of 10%, a case where a 10% deviation continues for two hours, a case where the weather forecast changes suddenly, and a case where an amount of received power from grid power changes suddenly due to an occurrence of a disaster or the like.

The management server 200 displays a warning screen on the display unit 240 and, at the same time, causes a display that prompts the manager to determine an energy management policy for the district to be displayed on the display unit 240. Specifically, the management server 200 causes the display unit 240 to display proposed energy management policies such as “suppress energy consumption” and “perform energy interchange to implement energy allocation from another district” as options. Subsequently, the management server 200 awaits selection of an energy management policy by the manager from these options and acquires the selection result with the input unit 230 (S350).

The manager determines the energy management policy in consideration of a status of energy use in an entire management area and the like. The management server 200 acquires change contents based on the determined energy management policy with the input unit 230 (S360) and transmits an instruction to an object building based on the change contents (S370).

For example, when the manager selects “suppress energy consumption” as the energy management policy, the management server 200 displays the intra-district energy prediction list 215 and the district unit energy prediction list 216 on the display unit 240 and causes the manager to select a district, a building, or the like as an object of suppressing energy consumption, and acquires the selection result with the input unit 230.

For example, the manager can select an entirety of one district as the object of suppressing energy consumption from the district unit energy prediction list 215. When this selection is made, the manager inputs a change amount (for example, 5%) which indicates a degree to which an amount of consumed energy is to be suppressed in the entire selected district. The management server 200 acquires the input and corrects predicted values of the intra-district energy prediction list 215 and the district unit energy prediction list 216 based on the input. Subsequently, based on the corrected predicted values, the management server 200 transmits an instruction to object buildings in order to control loads in the buildings so that energy consumption in all buildings in the district selected as the object of suppression is uniformly suppressed by 5%.

In addition, when the manager specifies a specific building on the intra-district energy prediction list 215 of a district that is an object of suppression, the management server 200 can transmit an instruction to suppress energy consumption to the specified building. In this case, the management server 200 changes a predicted value in the intra-district energy prediction list 215 which is related to the specified building and transmits an instruction to suppress energy consumption to loads in the building.

On the other hand, when the manager selects to “perform energy interchange to implement energy allocation from another district”, the management server 200 displays, on the display unit 240, information prompting the manager to set a district on which energy interchange is to be performed (an interchange source district) and an amount of interchanged energy. The manager selects a district on which energy interchange is to be performed via the input unit 230 while viewing actual values and predicted values of amounts of consumed energy for other districts which are displayed on the display unit 240 and inputs a setting for the amount of interchanged energy. The management server 200 corrects predicted values of the intra-district energy prediction list 215 and the district unit energy prediction list 216 based on the set information and, based on the corrected predicted values, transmits an instruction for power interchange to the power interchanging device 140b installed in a district to receive the power interchange.

Moreover, when the district to be the interchange destination is already receiving power allocated from another district at the point where the manager makes the selection regarding energy interchange, the manager can select either further increasing an amount of interchange energy allocation from the district, which has already been the interchange source of the power interchange, or newly receiving power allocated from a district that has not been involved in power interchange (in other words, start parallel power reception). Although the former case is to be accommodated by increasing output from storage batteries existing in the district responsible for supplying power, in the present embodiment, a power amount to be allocated from storage batteries is controlled so as to be equal to or less than the interchangeable remaining charge in the remaining charges of storage batteries existing in the district that is the interchange source.

When a deviation between an actual value and a new predicted value of the amount of consumed energy decreases as a result of performing the process described above, the management server 200 performs energy management as-is with the new predicted value. On the other hand, when the deviation does not decrease, the management server 200 may once again display a warning on the display unit to prompt the manager to take additional measures.

Moreover, when a current actual value of the amount of consumed energy in the district drops below the predicted value as a result of continuing management according to the intra-district energy prediction list 215 and the district unit energy prediction list 216 whose predicted values have been corrected, the management server 200 may output the status to the display unit 240 and prompt the manager to select either to perform energy management as-is using the predicted values of the intra-district energy prediction list 215 and the district unit energy prediction list 216 after correction or to revert to energy management using the predicted values of the intra-district energy prediction list 215 and the district unit energy prediction list 216 prior to the correction.

According to the energy management process described above, facilities in the respective districts can be controlled based on an energy management plan and the energy management plan can be corrected in cases where an amount of consumed energy exceeds the energy management plan or the like. Accordingly, energy supply and demand in a plurality of districts can be optimized.

In the energy management process, the management server 200 transmits display information for displaying a building management screen which integrates various types of information to terminal devices such as energy management devices in buildings to be managed by the management server 200. The terminal devices display the building management screen based on the display information.

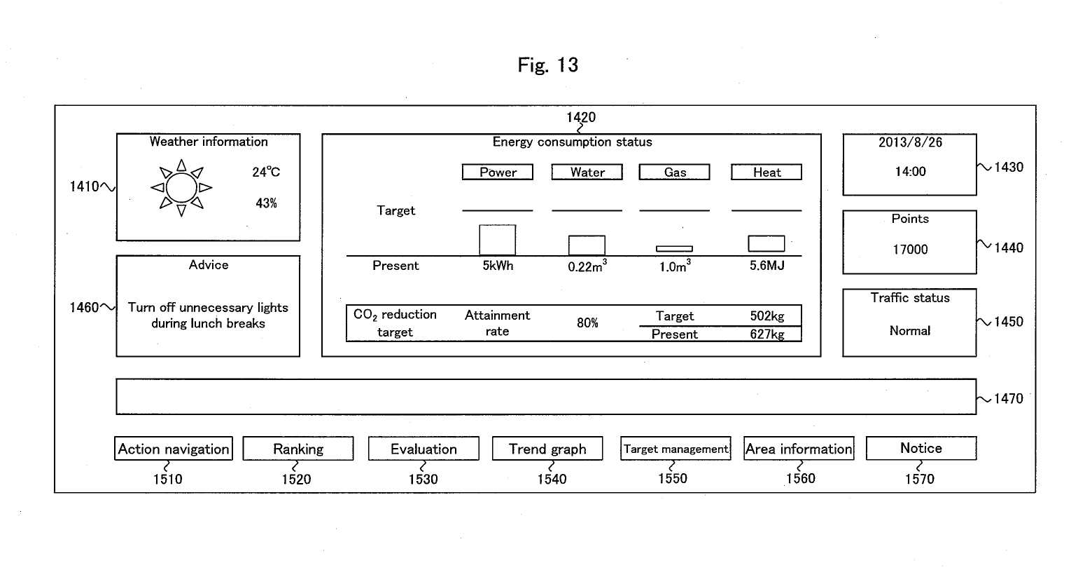

FIG. 13 illustrates a building management screen.

The building management screen provides various types of information to a building manager and prompts the building manager to take consumption suppressing actions and the like. For example, the building management screen includes weather information 1410, an energy consumption status 1420, time information 1430, incentive information 1440, a traffic status 1450, advice information 1460, emergency information 1470, an action navigation button 1510, a ranking button 1520, an evaluation button 1530, a trend graph button 1540, a target management button 1550, an area information button 1560, and a notice button 1570.

The weather information 1410 indicates future weather, temperature, humidity, and the like. The energy consumption status 1420 displays current actual values of amounts of consumed energy such as power, water, gas, and heat, target values of the amounts of consumed energy, past actual values of the amounts of consumed energy, and the like. The energy consumption status 1420 further indicates a target value and a current actual value of CO₂ emission, an attainment rate with respect to a CO₂ reduction target, and the like.

The time information 1430 indicates a current date, time, and the like. The incentive information 1440 displays points and the like which are awarded to the building manager as an incentive for suppressing an amount of consumed energy. The traffic status 1450 displays a current railway operation status and the like. The advice information 1460 prompts the building manager to suppress consumption behavior. For example, when a change in the weather Or a change in status necessitates suppression of energy consumption, the advice information 1460 is a message that prompts a specific measure for such suppression to be taken (for example, prompting switching from mechanical ventilation to natural ventilation since outside temperature has dropped and prompting reducing standby power since night-time power consumption has increased).

The emergency information 1470 displays, when an emergency such as an earthquake occurs, a status of the emergency, an evacuation route, and the like.

The action navigation button 1510 is a button that, for example, causes new advice information 1460 to be displayed. The ranking button 1520 is a button that, for example, causes rankings among residents of a same apartment to be displayed with respect to an attainment rate of a CO₂ reduction target. The evaluation button 1530 is a button that, for example, causes an evaluation of energy consumption by the building manager to be displayed. The trend graph button 1540 is a button that, for example, causes several consumption indices (amounts of consumption of power, water, gas, heat, and the like) to be displayed as a radar chart. The target management button 1550 is a button for, for example, setting a consumption index target. The area information button 1560 is a button that, for example, causes area information such as an event indicated in the holding information table 214 to be displayed. The notice button 1570 is a button that, for example, causes a message from the manager to the building manager to be displayed. The message is used when the manager is to perform suppression of consumed energy for an entire district or the building and when notifying a restriction of use of electrical appliances in the building (for example, a ban on use of lighting of shared facilities and a restriction of use of air conditioning facilities in residences) during rolling blackouts of a local municipality, during an unexpected blackout, or the like.

Next, the power interchanging device 140b will be described.

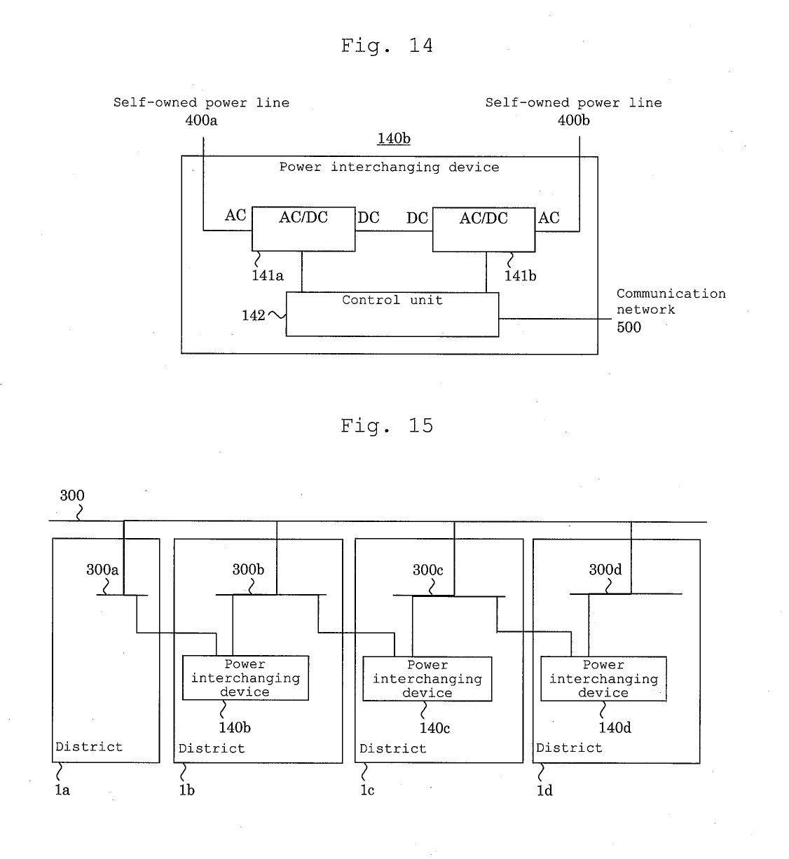

FIG. 14 illustrates a configuration of the power interchanging device 140b.

The power interchanging device 140b is connected to the power line 300a in the other district 1a via the self-owned power line 400a and, at the same time, connected to the power line 300b in the district 1b in which the power interchanging device 140b is installed via the self-owned power line 400b. In addition, the power interchanging device 140b includes AC/DC converters 141a and 141b and a control unit 142. An AC side of the AC/DC converter 141a is connected to the self-owned power line 400a, a DC side of the AC/DC converter 141b is connected to a DC side of the AC/DC converter 141a, and the self-owned power line 400b is connected to an AC side of the AC/DC converter 141b. The control unit 142 is connected to the communication network 500, receives an instruction from the management server 200 via the communication network 500, and controls the AC/DC converters 141a and 141b in accordance with the received instruction. By having the configuration described above, the power interchanging device 140b is capable of supplying power of the power-transmitting side district 1a to the power-receiving side district 1b by converting the power from alternating current to direct current and further converting the power from direct current to alternating current in accordance with the instruction from the management server 200 to absorb deviations (a difference in frequencies and/or a difference in phases) between the districts.

Moreover, the power-transmitting side and the power-receiving side are reversible and the power interchanging device 140b is capable of transmitting power in both directions. In other words, in accordance with the instruction from the management server 200, the power interchanging device 140b can convert power of the power-transmitting side district 1b from alternating current to direct current and further convert the power from direct current to alternating current to supply the power to the power-receiving side district 1a.

The power interchanging device 140b starts power interchange in accordance with an instruction from the management server 200 which manages the district 1b. Specifically, the management server 200 transmits an instruction including an amount of interchanged energy that indicates a magnitude of power to be interchanged by the power interchanging device 140b and an interchange direction that indicates a direction of the power via the communication network 500. In this case, the interchange direction refers to information describing that, for example, power is to be interchanged for allocation from the district 1a to the district 1b. More specifically, an interchange direction in a case where power is to be allocated from the district 1a to the district 1b is defined as a positive value and an opposite interchange direction is defined as a negative value.

The power interchanging device 140b having received the instruction controls the AC/DC converters 141a and 141b included in the power interchanging device 140b to ensure that power is interchanged according to the amount of interchanged energy and the interchange direction included in the instruction. Accordingly, the power interchanging device 140b can control power interchange in any amount of interchanged energy and any interchange direction. Moreover, when stopping power interchange between districts, the management server 200 transmits, for example, 0 as a value indicating the interchange direction to the power interchanging device 140b.

As described earlier, the management server 200 issues an instruction to the power interchanging device 140b when power interchange is set based on the intra-district energy prediction list 215 and the district unit energy prediction list 216. In addition, the management server 200 similarly issues an instruction to the power interchanging device 140b when the manager instructs power interchange to be performed in response to a deviation from a predicted value.

Hereinafter, several modifications of the power interchanging device will be described.

By performing power interchange with the power interchanging device 140b on the side of the district 1b provided in one of districts adjacent to one another, a case where a new district is set can be accommodated in a flexible manner.

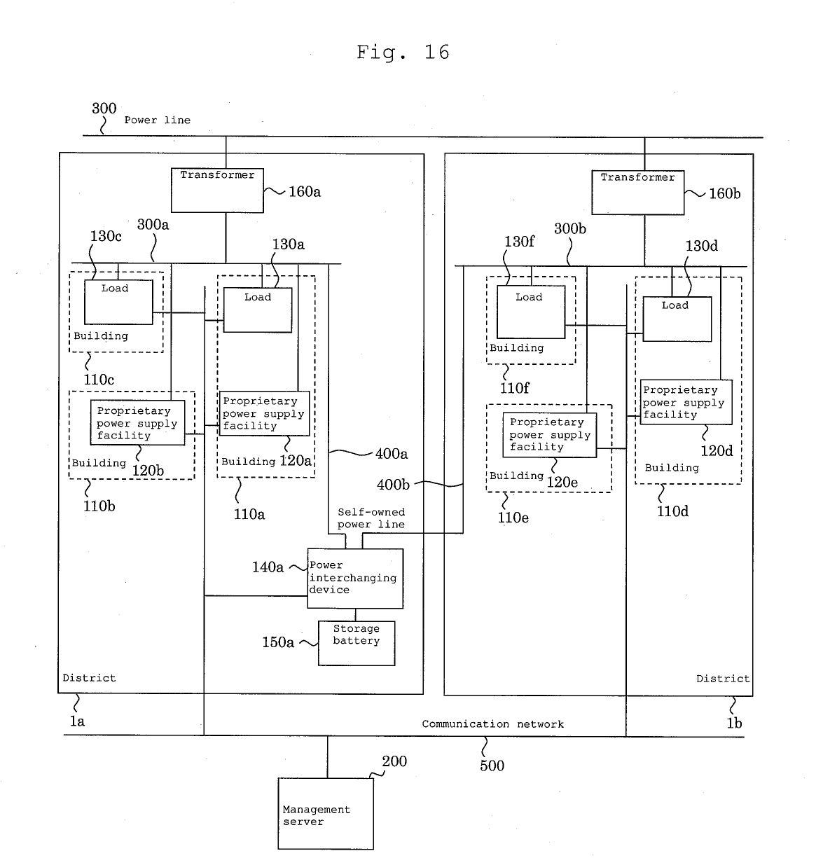

FIG. 15 schematically illustrates a configuration of an area energy management system in a case where a district is added to a management area.

Configurations of the districts 1a and 1b are similar to that illustrated in FIG. 1. When a new district 1c is added to the management area, the district 1c includes a power interchanging device 140c. The power interchanging device 140c is connected between a power line in the district 1b and a power line in the district 1c. When a new district 1d is further added to the management area, the district 1d includes a power interchanging device 140d. The power interchanging device 140d is connected between a power line in the district 1c and a power line in the district 1d. In this manner, by connecting a district provided with a power interchanging device to another district in series, the district can be added in a simple manner. In addition, the added district can effectively utilize power generated by power generating facilities of existing districts. The added district need not include a power generating facility.

Moreover, while interchange of power is performed using a power interchanging device on the side of a district receiving the power allocation in the present embodiment, the power interchange may be performed using a power interchanging device on a power supplying side.

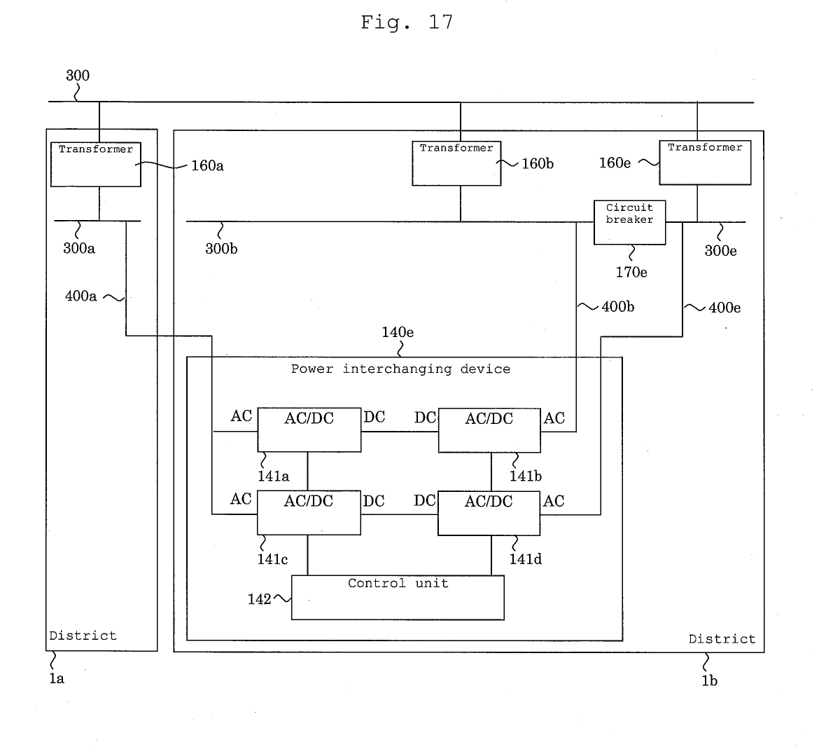

FIG. 16 schematically illustrates a configuration of an area energy management system in a case where a power interchanging device is provided in another district.

In FIG. 16, elements assigned the same reference signs as the elements illustrated in FIG. 1 represent elements that are the same or comparable to the elements illustrated in FIG. 1. The area energy management system includes a power interchanging device 140a in the district 1a in place of the power interchanging device 140b in the district 1b. A storage battery 150a is connected to the power interchanging device 140a and power interchange to allocate power to the other district 1b is performed by controlling the storage battery 150a. In the case of this example, when newly adding a district, the district 1a including the power interchanging device 140a and the new district may be connected to each other, a power interchanging device may be newly installed in the district 1b that does not include a power interchanging device, or a power interchanging device may be installed in the new district.

FIG. 17 schematically illustrates a configuration of an area energy management system in a case where a power line in a district includes a plurality of sections.

A configuration of the district 1a is similar to that illustrated in FIG. 1. Compared to the configuration illustrated in FIG. 1, the district 1b includes a power interchanging device 140e in place of the power interchanging device 140b and further includes a transformer 160e, a circuit breaker 170e, and a power line 300e. A section switch or the like may be used in place of the circuit breaker 170e.

A power line in the district 1b can be divided by the circuit breaker 170e into a section of the power line 300b and a section of the power line 300e. The power line 300e is connected to the power line 300 via the transformer 160e.

The power interchanging device 140e is connected to self-owned power lines 400a and 400b and connected via the self-owned power line 400e to the power line 300e in a similar manner to the power interchanging device 140b. In addition to the elements of the power interchanging device 140b, the power interchanging device 140e includes AC/DC converters 141c and 141d. An AC side of the AC/DC converter 141c is connected to the self-owned power line 400a, a DC side of the AC/DC converter 141d is connected to a DC side of the AC/DC converter 141c, and the self-owned power line 400e is connected to an AC side of the AC/DC converter 141d. The control unit 142 controls the AC/DC converters 141a, 141b, 141c, and 141d in accordance with an instruction from the management server 200. According to this configuration, the power interchanging device 140e can perform power interchange between the power line 300a of the district 1a and the power line 300b of the district 1b in a similar manner to the power interchanging device 140b and, at the same time, perform power interchange between the power line 300a of the district 1a and the power line 300e of the district 1b. Accordingly, even when a power failure occurs on any of the power lines 300b and 300e, power interchange can be performed using the remaining section.

While an area energy management system which manages power has been described in the present embodiment, the area energy management system according to the present invention can be applied to the management of other forms of energy such as gas, water, and heat.

Terms used in the energy management system according to the present invention will be described. The energy management system corresponds to an area energy management system and the like. The management computer corresponds to the management server and the like. The first district corresponds to the district 1b and the like. The second district corresponds to the district 1a and the like.

### REFERENCE SIGNS LIST

1a, 1b, 1c, 1d District
110a, 110b, 110d, 110e Building
120a, 120c, 120d, 120f Proprietary power supply facility
130a, 130b, 130d, 130e Load
140a, 140b, 140c, 140d, 140e Power interchanging device
141a, 141b Converter
142 Control unit
150a Storage battery
160a, 160b Transformer
180a, 180b Energy management device
200 Management server
210 Data storage unit
220 Computing unit
230 Input unit
240 Display unit
250 Communicating unit
300, 300a, 300b Power line
400a, 400b Self-owned power line
500 Communication network

1. An energy management system that manages energy for a plurality of districts including a plurality of facilities, the energy management system comprising
a management computer connected to the plurality of districts via a communication network, wherein
the management computer includes:
a data storage unit configured to store, for each district of the plurality of districts, an actual value of an amount of grid energy that indicates an amount of energy supplied from outside of the plurality of districts to facilities inside the district, an actual value of an amount of output energy that indicates an amount of energy output from the facilities in the district, and an actual value of an amount of consumed energy that indicates an amount of energy consumed by the facilities in the district; and
a computing unit configured to calculate and output, for the district, a predicted value of the amount of grid energy, a predicted value of the amount of output energy, and a predicted value of the amount of consumed energy in a specific time slot, based on the actual value of the amount of grid energy, the actual value of the amount of output energy, and the actual value of the amount of consumed energy.

2. The energy management system according to claim 1, wherein
the computing unit is configured to control facilities connected to the management computer via the communication network, based on the predicted value of the amount of grid energy, the predicted value of the amount of output energy, and the predicted value of the amount of consumed energy in the specific time slot.

3. The energy management system according to claim 2, which calculates a predicted value of an amount of supplied energy which is a sum of the predicted value of the amount of grid energy and the predicted value of the amount of output energy; and when a predicted value of the amount of consumed energy exceeds a predicted value of the amount of supplied energy in a first district among the plurality of districts, makes determination to implement energy interchange to allocate energy to the first district from a second district among the plurality of districts in the specific time slot, changes and outputs the predicted value of the amount of grid energy, the predicted value of the amount of output energy, and the predicted value of the amount of consumed energy, based on the interchange, and transmits a first interchange instruction indicating the interchange to any of the first district and the second district via the communication network.

4. The energy management system according to claim 3, wherein
the energy is power, and
the energy management system further comprises a power interchanging device which is connected to the management computer via the communication network, and which is configured to receive the first interchange instruction, and implement power interchange to allocate power from the second district to the first district, based on the first interchange instruction.

5. The energy management system according to claim 4, wherein
the power interchanging device includes:
a first power converter configured to convert alternating current power input from the second district into direct current power, based on the first interchange instruction; and
a second power converter configured to convert direct current power output from the first power converter into alternating current power and outputs the converted power to the first district, based on the first interchange instruction.

6. The energy management system according to claim 5, wherein
the second district includes a power generating facility, and the computing unit is configured to make a determination to implement power interchange to allocate power based on power generation by the power generating facility from the second district to the first district, based on a predicted value of an amount of output energy of the power generating facility.

7. The energy management system according to claim 6, wherein
the second district includes a storage battery,
the data storage unit is configured to store an actual value of a remaining charge of the storage battery and an actual value of an interchangeable remaining charge which is charged from the power generating facility in the remaining charge of the storage battery, the computing unit is configured to calculate a predicted value of the interchangeable remaining charge, based on the actual value of the amount of grid energy, the actual value of the amount of output energy, and the actual value of the amount of consumed energy, and
the power based on power generation by the power generating facility includes any of power generated by the power generating facility and power due to discharge of the interchangeable remaining charge.

8. The energy management system according to claim 5, wherein
when the computing unit makes a determination to implement power interchange to allocate power from the first district to the second district in the specific time slot, the computing unit transmits to the power interchanging device via the communication network a second interchange instruction to implement power interchange to allocate power from the first district to the second district in the specific time slot, and
when the power interchanging device receives the second interchange instruction, the power interchanging device implements power interchange to allocate power from the first district to the second district, based on the second interchange instruction.

9. The energy management system according to claim 6, wherein
the power interchanging device is provided in the first district.

10. The energy management system according to claim 3, wherein
when determination is made that a magnitude of a difference between a predicted value and an actual value in the first district exceeds a prescribed value, the computing unit causes a display device to display a plurality of proposed energy management policies including suppressing an amount of consumed energy in the first district and the interchange, acquires input from a manager, determines an energy management policy from the plurality of proposed energy management policies, based on the input, and transmits an instruction indicating the energy management policy to any of the first district and the second district via the communication network.

11. The energy management system according to claim 10, wherein
the computing unit is configured to store a history of actual values of the amount of grid energy, actual values of the amount of output energy, and actual values of the amount of consumed energy, and calculate the predicted value of the amount of grid energy, the predicted value of the amount of output energy, and the predicted value of the amount of consumed energy, based on the history.

12. The energy management system according to claim 11, wherein
for each of the plurality of districts, the computing unit is configured to store an energy consumption pattern indicating consumption of energy in each time slot, and calculate the predicted value of the amount of consumed energy, based on the energy consumption pattern.

13. An energy management method of managing energy for a plurality of districts including a plurality of facilities, the method causing a management computer connected to the plurality of districts via a communication network to execute a process comprising:
storing, for each district of the plurality of districts, an actual value of an amount of grid energy that indicates an amount of energy supplied from outside of the plurality of districts to facilities inside the district, an actual value of an amount of output energy that indicates an amount of energy output from the facilities in the district, and an actual value of an amount of consumed energy that indicates an amount of energy consumed by the facilities in the district; and
calculating and outputting, for the district, a predicted value of the amount of grid energy, a predicted value of the amount of output energy, and a predicted value of the amount of consumed energy in a specific time slot, based on the actual value of the amount of grid energy, the actual value of the amount of output energy, and the actual value of the amount of consumed energy.
